(19) United States
(12) Patent Application Publication
(10) Pub. No.: US 2026/0058572 A1
(43) Pub. Date: Feb. 26, 2026

(54) ELECTRIFIED VEHICLE

(71) Applicants: HYUNDAI MOTOR COMPANY, Seoul (KR); KIA CORPORATION, Seoul (KR); Seoul National University R&DB Foundation, Seoul (KR)

(72) Inventors: Yoo Jong Lee, Hwaseong-si (KR); Byung Kwan Son, Hwaseong-si (KR); Jin Su Hong, Hwaseong-si (KR); Gyu Cheol Lim, Seoul (KR); Junhyuk Yang, Seoul (KR); Cheolmin Hwang, Seoul (KR); Jung-lk Ha, Seoul (KR)

(73) Assignees: HYUNDAI MOTOR COMPANY, Seoul (KR); KIA CORPORATION, Seoul (KR); Seoul National University R&DB Foundation, Seoul (KR)

(21) Appl. No.: 19/228,435

(22) Filed: Jun. 4, 2025

(30) Foreign Application Priority Data
Aug. 23, 2024 (KR) 10-2024-0113799

(51) Int. Cl. H02M 7/537; B60L 50/60; B60L 53/22

(52) U.S. Cl. CPC H02M 7/537; B60L 50/60; B60L 53/22; B60L 2240/547

(57) ABSTRACT

Disclosed is an electric vehicle including a motor having a plurality of windings, a dual inverter having a first DC link and a second DC link and connected to the motor, a charging terminal to which a charging voltage is applied, and a plurality of nodes. The plurality of nodes include a first node formed between a positive electrode of the charging terminal and the other end of any one of the plurality of windings, a second node formed between a negative electrode of the charging terminal and a negative electrode of the first DC link, a third node formed between the negative electrode of the charging terminal and a negative electrode of the second DC link, and a fourth node formed between the second node, the third node, and the negative electrode of the charging terminal.

### CROSS-REFERENCE TO THE RELATED APPLICATION

This application claims priority from Korean Patent Application No. 10-2024-0113799, filed on Aug. 23, 2024, in the Korean Intellectual Property Office, the disclosure of which is incorporated herein by reference in its entirety.

### TECHNICAL FIELD

The present disclosure relates to an electrified vehicle having a plurality of batteries connected to a dual inverter.

### BACKGROUND

Recently, with the increasing interest in the environment, eco-friendly vehicles equipped with electric motors as a power source are on the rise. Eco-friendly vehicles are also called electric vehicles, and representative examples include hybrid vehicles (HEVs) and electric vehicles (EVs).

For small or light electric vehicles, cost competitiveness is considered, and cost reduction of not only high-voltage batteries but also power electronics (PE) components is also considered. Among high-voltage power electronics components, an expensive component is the high-voltage battery, and the price of power electronics components can be reduced by minimizing the capacity of the high-voltage battery. However, if the capacity of the high-voltage battery is reduced, not only does the range of the electric vehicle decrease, but also the output of the motor and inverter decreases.

Therefore, a motor drive system having multiple independent batteries as a voltage source may be useful.

The matters described as background technology above are intended to enhance understanding of the background of the present disclosure and should not be taken as an acknowledgment that they correspond to prior art already known to those skilled in the art.

### SUMMARY

Therefore, the present disclosure has been made in view of the above problems, and an object of the present disclosure is to provide an electrified vehicle capable of forming a charging path for charging (e.g, all of) a plurality of batteries connected to a dual inverter (e.g., even) when charging conditions of the plurality of batteries are different.

The object of the present disclosure is not limited to the object mentioned above, and other tasks not mentioned may be understood by those skilled in the art from the description below.

In accordance with an aspect of the present disclosure, the above and other objects may be accomplished by the provision of an electrified vehicle including a motor having a plurality of windings corresponding to a plurality of phases, a first inverter having a first DC link to which a first battery is connected and a plurality of legs connected to one end of (e.g., each of) the plurality of windings, a second inverter having a second DC link to which a second battery is connected and a plurality of legs connected to the other end of (e.g., each of) the plurality of windings, a charging terminal to which a charging voltage of an external charger is applied while the external charger is connected to the charging terminal, and a plurality of nodes including a first node formed between a positive electrode of the charging terminal and the other end of any one of the plurality of windings, a second node formed between a negative electrode of the charging terminal and a negative electrode of the first DC link, a third node formed between the negative electrode of the charging terminal and a negative electrode of the second DC link, and a fourth node formed between the second node, the third node, and the negative electrode of the charging terminal.

For example, the electrified vehicle may further include a controller configured to determine a charging path for the first battery and the second battery by controlling the first inverter and the second inverter based on voltages of the first battery and the second battery and a maximum charging voltage applicable to the charging terminal.

For example, the voltage of the first battery may be equal to or higher than the voltage of the second battery, and the controller may control the first inverter and the second inverter based on the voltage of the second battery and the maximum charging voltage.

For example, the controller may control the first inverter and the second inverter, such that a charging path, through which the second battery is directly charged with a charging voltage and the first battery is charged using a voltage of the second battery, is formed when the maximum charging voltage is equal to or higher than the voltage of the second battery.

For example, the controller may control the first inverter and the second inverter such that current caused by the charging voltage is transmitted to the second battery via the first node and the second inverter.

For example, the controller may control a switching state of the second inverter such that a leg connected to the first node among the plurality of legs of the second inverter is connected to a positive electrode of the second DC link.

For example, the controller may control the first inverter and the second inverter such that the voltage of the second battery is converted to match the voltage of the first battery through the plurality of windings.

For example, the controller may control the switching state of the second inverter such that the plurality of legs of the second inverter is connected to the positive electrode of the second DC link, and the controller may control a switching state of the first inverter such that the voltage of the second battery is converted to match the voltage of the first battery through the plurality of windings.

For example, the controller may control the first inverter and the second inverter such that phase currents applied to the plurality of windings have the same magnitude.

For example, the controller may control the first inverter and the second inverter such that a charging path through which the first battery is charged with the charging voltage and the second battery is charged using the voltage of the first battery when the maximum charging voltage is lower than the voltage of the second battery.

For example, the controller may control the first inverter and the second inverter such that the current caused by the charging voltage is transmitted to the first battery via the first node, a winding connected to the first node among the plurality of windings, and the first inverter.

For example, the controller may control a switching state of a leg connected to the first node among the plurality of legs of the first inverter such that the charging voltage is converted to match the voltage of the first battery through the winding connected to the first node among the plurality of windings.

For example, the controller may control the first inverter and the second inverter such that a current caused by the voltage of the first battery is transmitted to the second battery via windings not connected to the first node, among the plurality of windings, and the second inverter.

For example, the controller may control switching states of legs not connected to the first node among the plurality of legs of the first inverter such that the voltage of the first battery is converted to match the voltage of the second battery through the windings not connected to the first node among the plurality of windings.

For example, the controller may control the first inverter and the second inverter such that the phase currents applied to the plurality of windings have the same magnitude.

For example, the electrified vehicle may further include a first switch electrically connecting the first node and the positive electrode of the charging terminal in a turn-on state, a second switch electrically connecting the second node and the negative electrode of the charging terminal in a turn-on state, and a third switch electrically connecting the third node and the negative electrode of the charging terminal in a turn-on state.

### BRIEF DESCRIPTION OF THE DRAWINGS

The above and other objects, features and other advantages of the present disclosure will be understood from the following detailed description taken in conjunction with the accompanying drawings, in which:

FIG. 1 is a diagram showing a configuration of an electrified vehicle according to an embodiment of the present disclosure; and

FIGS. 2, 3, 4, and FIG. 5 are diagrams showing charging paths for an electrified vehicle according to embodiments of the present disclosure.

### DETAILED DESCRIPTION

Specific structural and functional descriptions of the embodiments of the present disclosure, disclosed in the present application, are illustrative for the purpose of explaining the embodiments according to the present disclosure, and the embodiments according to the present disclosure may be implemented in various forms and should not be construed as being limited to the embodiments described in this application.

Since the embodiments according to the present disclosure can be modified in various manners and have various forms, specific embodiments will be illustrated in the drawings and described in detail in the application. However, this is not intended to limit the embodiments according to the concept of the present disclosure to a specific disclosed form, and should be understood to include (e.g., all) changes, equivalents, and substitutes included in the spirit and technical scope of the present disclosure.

Terms including technical or scientific terms have the same meanings as generally understood by a person having ordinary skill in the art to which the present disclosure pertains unless mentioned otherwise. Generally used terms, such as terms defined in a dictionary, should be interpreted to coincide with meanings of the related art from the context. Unless differently defined in the present disclosure, such terms should not be interpreted in an ideal or excessively formal manner.

Hereinafter, embodiments disclosed in the present specification will be described in detail with reference to the attached drawings. However, the same or similar components will be assigned the same reference numeral, and redundant descriptions thereof will be omitted.

In the description of the following embodiments, the term “preset” discloses that the value of a parameter is predetermined when the parameter is used in a process or an algorithm. Depending on embodiments, the value of a parameter may be set when a process or an algorithm starts or may be set during a period in which the process or the algorithm is performed.

The terms “module” and “unit or part” used to signify components are used herein to help the understanding of the components and thus should not be considered as having specific meanings or roles.

In the following description of the embodiments disclosed in the present application, a detailed description of known functions and configurations incorporated herein will be omitted when it may obscure the subject matter of the present disclosure. In addition, the accompanying drawings are provided for ease of understanding of the embodiments disclosed in the present specification, do not limit the technical spirit disclosed herein, and include changes, equivalents and substitutes included in the spirit and scope of the present disclosure.

The terms “first” and/or “second” are used to describe various components, but such components are not limited by these terms. The terms are used to distinguish one component from another component.

When a component is “coupled” or “connected” to another component, it should be understood that a third component may be present between the two components although the component may be (e.g., directly) coupled or connected to the other component. When a component is “directly coupled” or “directly connected” to another component, it should be understood that no element is present between the two components.

An element described in the singular form is intended to include a plurality of elements unless the context clearly indicates otherwise.

In the present specification, it will be further understood that the term “comprise” or “include” specifies the presence of a stated feature, figure, step, operation, component, part or combination thereof, but does not preclude the presence or addition of one or more other features, figures, steps, operations, components, or combinations thereof.

In addition, a unit or a control unit included in names such as a motor control unit (MCU) and a hybrid control unit (HCU) may be used in naming a control device that controls specific vehicle functions and may not mean a generic functional unit.

A controller may include a communication device that communicates with other controllers or sensors to control the functions of the controller, a memory that stores an operating system, logic instructions, input/output information, or the like, and one or more processors that perform determination, computation, and decisions (e.g., necessary) to control the functions.

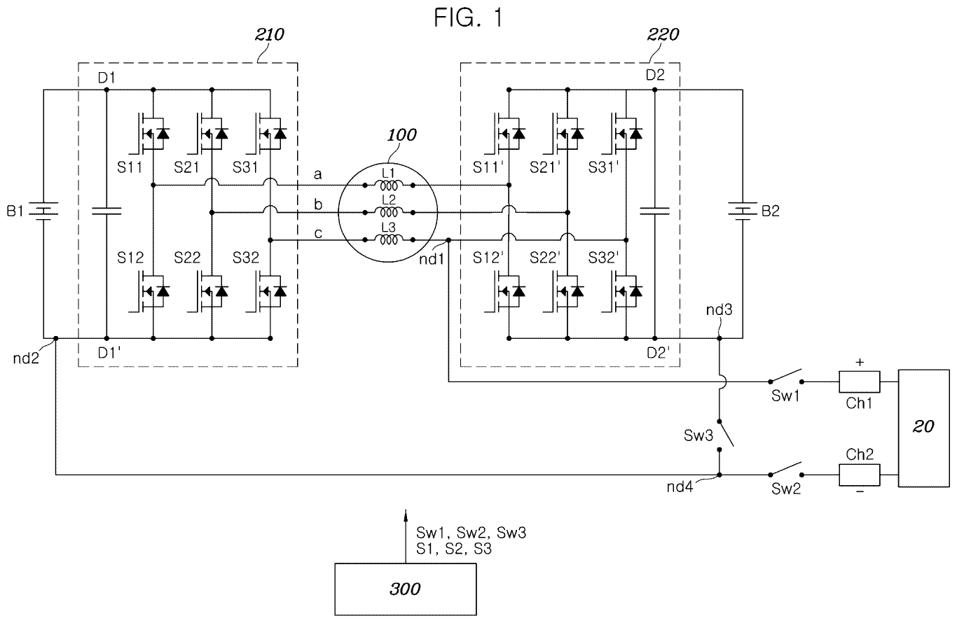

Referring to FIG. 1, an electrified vehicle according to an embodiment of the present disclosure includes a motor 100, a dual inverter (e.g., a first inverter 210 and a second inverter 220), a first battery B1, a second battery B2, a charging terminal Ch1 and Ch2, a plurality of switches Sw, and a controller 300.

Referring to FIG. 1, the motor 100 has a plurality of windings L1, L2, and L3 corresponding to a first phase a, a second phase b, and a third phase c.

The dual inverter includes the first inverter 210 and the second inverter 220 which are connected to both ends of (e.g., each of) the plurality of windings L1, L2, and L3. Specifically, the first inverter 210 has DC link D1 and D1′ and a plurality of legs S11-S12, S21-S22, and S31-S32 connected to one end of (e.g., each of) the plurality of windings L1, L2, and L3, and the second inverter 220 has a second DC link D2 and D2′ and a plurality of legs S11′-S12′, S21′-S22′, and S31′-S32′ connected to the other end (e.g., of each) of the plurality of windings L1, L2, and L3. The legs are connected to top switching elements S11, S21, S31, S11′, S21′, and S31′ and bottom switching elements S12, S22, S32, S12′, S22′, and S32′, and each element may be implemented as a transistor such as a metal-oxide-semiconductor field effect transistor (MOSFET) or an insulated gate bipolar transistor (IGBT).

The charging terminal Ch1 and Ch2 may have a positive electrode Ch1 connected to a positive electrode D1 of the first DC link, and a negative electrode Ch2 connected to a negative electrode D2′ of the second DC link. An external charger 20 may be connected to the charging terminal Ch1 and Ch2 to apply a charging voltage, and (e.g., in this case,) relays RLY1 and RLY2 may be provided between the charging terminal Ch1 and Ch2 and the first DC link D1 and the second DC link D2′.

The first battery B1 is connected to the first DC link D1 and D1′, the second battery B2 is connected to the second DC link D2 and D2′, and the first battery B1 and the second battery B2 may be charged by the charging voltage applied to the charging terminal Ch1 and Ch2. In this case, the first battery B1 and the second battery B2 may be charged independently, for example, only the first battery B1 may be charged, or only the second battery B2 may be charged. In addition, the first battery B1 and the second battery B2 may have different types and specifications, and thus may have different voltages.

In an embodiment of the present disclosure, the first battery B1 and the second battery B2 may be charged together, and in particular, even when the charging conditions of the first battery B1 and the second battery B2 are different, both the first battery B1 and the second battery B2 may be charged.

In order to form a charging path through which both the first battery B1 and the second battery B2 can be charged as described herein, the electrified vehicle according to an embodiment may include a plurality of nodes, including a first node nd1 formed between the positive electrode Ch1 of the charging terminal and the other end of one of the plurality of windings L1, L2, and L3, a second node nd2 formed between the negative electrode Ch2 of the charging terminal and the negative electrode D1′ of the first DC link, a third node nd3 formed between the negative electrode Ch2 of the charging terminal and the negative electrode D2′ of the second DC link, and a fourth node nd4 formed between the second node nd2, the third node nd3 and the negative electrode Ch2 of the charging terminal.

A plurality of switches (e.g., in this case) may be provided between the motor 100, the first inverter 210, the second inverter 220, and the charging terminal Ch1 and Ch2, and when the plurality of switches is turned on, a charging path can be formed through each node nd1, nd2, nd3, and nd4. More specifically, the plurality of switches may include a first switch Sw1 that electrically connects the first node nd1 and the positive electrode ch1 of the charging terminal in a turn-on state, a second switch Sw2 that electrically connects the second node nd2 and the negative electrode Ch2 of the charging terminal in a turn-on state, and a third switch Sw3 that electrically connects the third node nd3 and the negative electrode Ch2 of the charging terminal in a turn-on state.

The controller 300 can control the first inverter 210 and the second inverter 220 based on the voltages of the first battery B1 and the second battery B2 and a maximum charging voltage applicable to the charging terminal Ch1 and Ch2 while the plurality of switches as described herein is turned on, thereby forming a charging path through which (e.g., both) the first battery B1 and the second battery B2 are charged.

In an embodiment, the controller 300 may be implemented as a motor control unit (MCU) and may be connected to a battery management system (BMS) equipped in the vehicle to obtain the voltages and charging current commands of the first battery B1 and the second battery B2. Alternatively, the controller 300 may be implemented as a high-level controller such as a vehicle control unit (VCU) or a hybrid control unit (HCU) having the functions of the motor control unit (MCU) and the battery management system (BMS). In addition, the maximum charging voltage is a maximum value of a charging voltage applicable to the charging terminal Ch1 and Ch2, and the value thereof may be determined according to the specifications of the external charger connected to the charging terminal. The controller 300 may obtain the maximum charging voltage, for example, through communication with the external charger.

The controller 300 may determine a charging path for the first battery B1 and the second battery B2 by controlling switching states of the first inverter 210 and the second inverter 220. Here, switching state control of the first inverter 210 and the second inverter 220 may be performed by controlling on/off of the top switching elements and the bottom switching elements of the legs S11-S12, S21-S22, S31-S32, S11′-S12′, S21′-S22′, and S31′-S32′ included in the first inverter 210 and the second inverter 220 through switching signals Sa, Sb, and Sc for the respective phases. The controller 300 (e.g., in this case) can control the currents flowing through the phases a, b, and c such that they have the same value, thereby preventing rotation of the connected motor 100 while the first battery B1 and the second battery B2 are being charged through the first inverter 210 and the second inverter 220.

According to the electrified vehicle having the plurality of switches Sw and the controller 300 (e.g., described herein), even when the charging conditions of the first battery B1 and the second battery B2 serve as a dual voltage source in a dual inverter structure having a dual voltage source are different, both the first battery B1 and the second battery B2 can be charged with a single power source. Accordingly, it is proposed to perform battery charging with (e.g., optimal) efficiency in various charging scenarios according to the charging conditions of the first battery B1 and the second battery B2.

Here, the charging conditions of the first battery B1 and the second battery B2 may be determined according to voltages of the first and second batteries B1 and B2, charging current commands, and the relationship between the voltages and the maximum charging voltage.

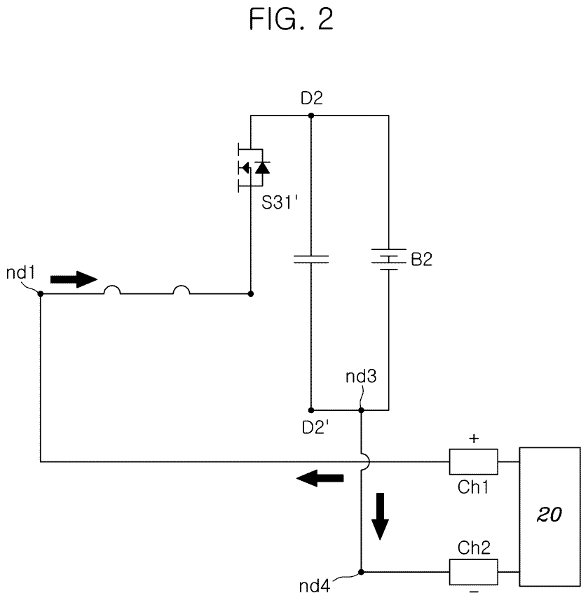

Hereinafter, specific control methods for (e.g., efficiently) charging both the first battery B1 and the second battery B2 in cases where the charging conditions of the first battery B1 and the second battery B2 are different will be described with reference to FIG. 2 to FIG. 5.

FIGS. 2, 3, 4, and 5 are diagrams showing charging paths for an electrified vehicle according to an embodiment of the present disclosure.

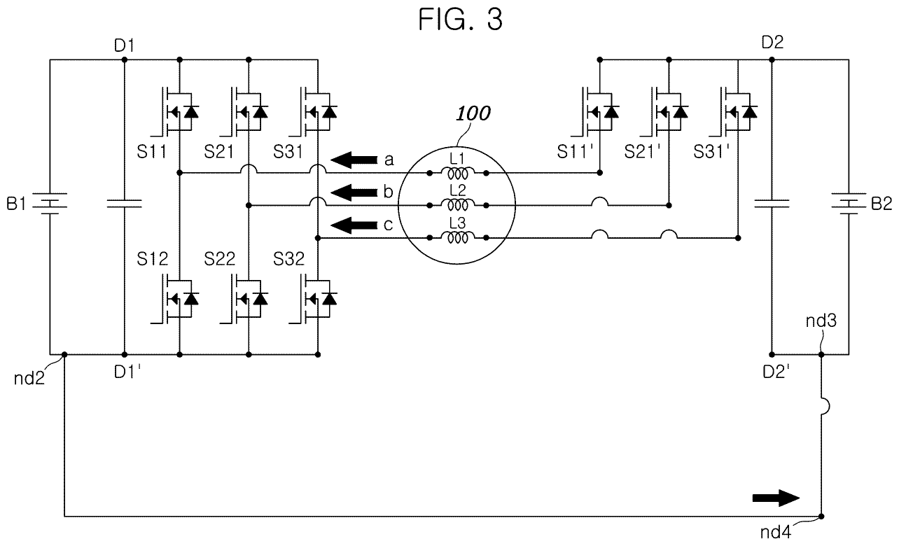

First, referring to FIG. 2 and FIG. 3, the controller 300 according to an embodiment may control the first inverter 210 and the second inverter 220 based on a lower voltage between the voltages of the first battery B1 and the second battery B2 and the maximum charging voltage. The voltages of the first battery B1 and the second battery B2 may vary depending on the implementation, but it may be (e.g., assumed) that the voltage of the second battery B2 is lower than the voltage of the first battery B1 in the following description.

More specifically, the controller 300 may control the first inverter 210 and the second inverter 220 such that a charging path, through which the second battery B2 is (e.g., directly) charged with a charging voltage and the first battery B1 is charged using the voltage of the second battery B2, is formed when the maximum charging voltage is higher than the voltage of the second battery B2.

Referring to FIG. 2, the controller 300 may control the first inverter 210 and the second inverter 220 such that the current caused by the charging voltage is transmitted to the second battery B1 through the first node nd1 and the second inverter 220. More specifically, the controller 300 (e.g., in this case) may turn on a relevant top switching element of the second inverter 220 such that the leg S31′-S32′ connected to the first node nd1 is connected to the positive electrode D2 of the second DC link, thereby allowing the current caused by the charging voltage to be (e.g., directly) transmitted to the second battery B2 without passing through the plurality of windings L1, L2, and L3.

Referring to FIG. 3, the controller 300 may control the first inverter 210 and the second inverter 220 such that the voltage of the second battery B2 is converted to match the voltage of the first battery B1 through the plurality of windings L1, L2, and L3.

In this case, the controller 300 may control the switching state of the second inverter 220 such that the plurality of legs S11′-S12′, S21′-S22′, and S31′-S32′ of the second inverter 220 are connected to the positive electrode D2 of the second DC link and may control the switching state of the first inverter 210 such that the voltage of the second battery B2 is converted to match the voltage of the first battery B1 through the plurality of windings L1, L2, and L3.

More specifically, the controller 300 may turn on the top switching elements S11′, S21′, and S31′) of the second inverter 220 such that the plurality of legs S11′-S12′, S21′-S22′, and S31′-S32′ are connected to the positive electrode D2 of the second DC link, and may convert the voltage of the second battery B2 by (e.g., complementarily) turning on/off the top switching elements S11, S21, and S31 and the bottom switching elements S12, S22, and S32 included in the plurality of legs S11-S12, S21-S22, and S31-S32 of the first inverter 210.

Meanwhile, the charging paths illustrated in FIG. 2 and FIG. 3 may not be formed separately but simultaneously, and accordingly, the first battery B1 and the second battery B2 are charged together.

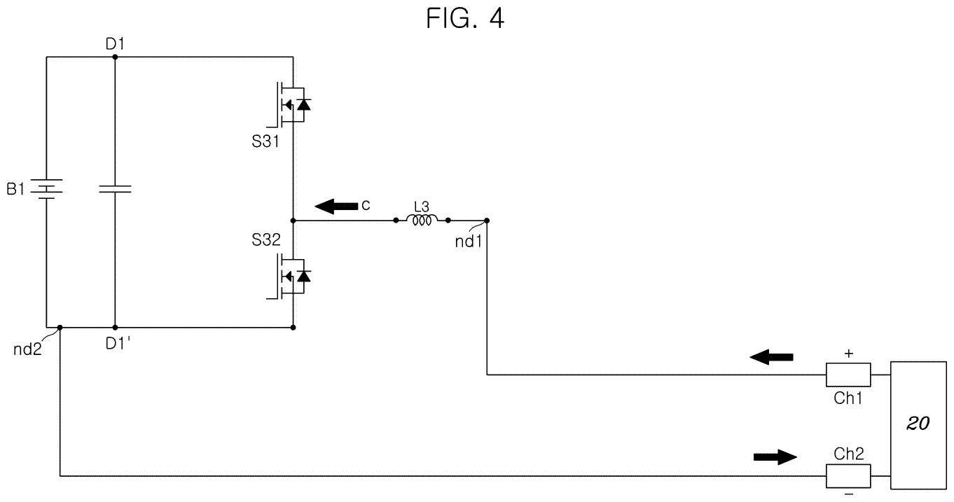

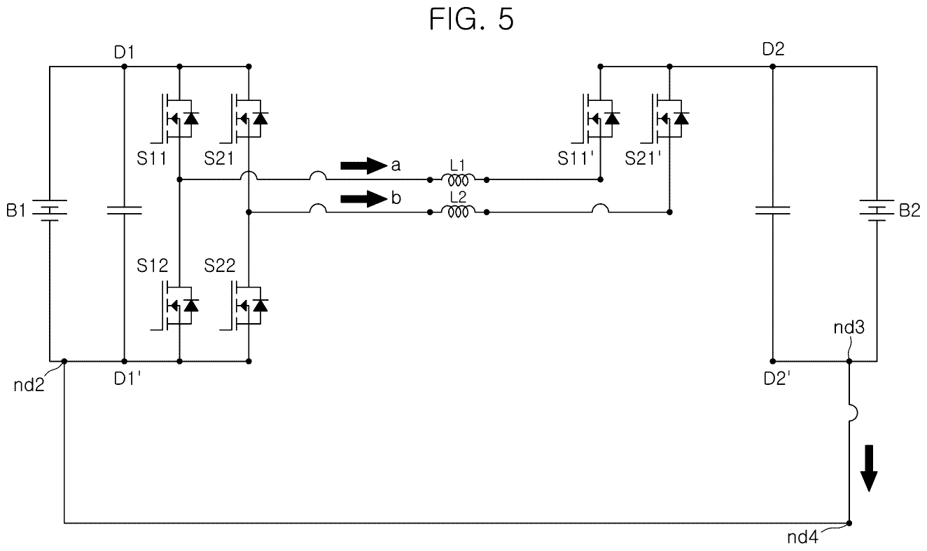

In comparison to the case illustrated in FIGS. 2 and 3, when the maximum charging voltage is lower than the voltage of the second battery, the controller 300 may control the first inverter 210 and the second inverter 220 such that a charging path, through which the first battery B1 is charged with the charging voltage and the second battery B2 is charged using the voltage of the first battery B1, is formed, as illustrated in FIG. 4 and FIG. 5.

Referring to FIG. 4, the controller 300 may control the first inverter 210 and the second inverter 220 such that the current caused by the charging voltage is transmitted to the first battery B1 through the first node nd1, the winding L3 connected to the first node nd1 among the plurality of windings L1, L2, and L3, and the first inverter 210.

The controller 300 (e.g. in this case) may control the switching state of the leg S31-S32 connected to the first node nd1 among the plurality of legs S11-S12, S21-S22, and S31-S32 of the first inverter 210 such that the charging voltage is converted to match the voltage of the first battery B1 through the winding L3 connected to the first node nd1 among the plurality of windings L1, L2, and L3.

Referring to FIG. 5, the controller 300 may control the first inverter 210 and the second inverter 220 such that the voltage of the first battery B1 is transmitted to the second battery B2 through the windings L1 and L2 that are not connected to the first node nd1 among the plurality of windings L1, L2, and L3 and the second inverter 220.

In this case, the controller 300 may control the switching states of the legs S11-S12 and S21-S22 that are not connected to the first node nd1 among the plurality of legs of the first inverter 210 such that the voltage of the first battery B1 is converted to match the voltage of the second battery B2 through the windings L1 and L2 that are not connected to the first node nd1 among the plurality of windings L1, L2, and L3. In addition, the controller 300 may control the top switching elements S11′ and S21′ of the legs S11′-S12′, S21′-S22′, and S31′-S32′ of the second inverter 220 to be turned on such that the current passing through the windings L1 and L2 can be transferred to the second battery B2.

Meanwhile, the charging paths illustrated in FIG. 4 and FIG. 5 may not be formed separately but simultaneously, and accordingly, the first battery B1 and the second battery B2 are charged together.

According to various embodiments of the present disclosure as described above, even when the charging conditions of a plurality of batteries serving as a dual voltage source of an electrified vehicle are different, it is possible to charge (e.g., all of) the batteries with a single power source.

Furthermore, in various charging scenarios according to the charging conditions of the plurality of batteries, battery charging can be performed with (e.g., optimal) efficiency.

The effects that can be obtained from the present disclosure are not limited to the effects mentioned above, and other effects that are not mentioned may be understood by those skilled in the art from the description herein.

Although the present disclosure has been illustrated and described with respect to specific embodiments as described above, it will be apparent to those skilled in the art that the present disclosure can be improved and changed in various manners without departing from the technical spirit of the present disclosure provided by the claims.

What is claimed is:

1. An electrified vehicle comprising:
a motor including a plurality of windings corresponding to a plurality of phases;
a first inverter including a first DC link to which a first battery is connected, and a plurality of legs connected to one end of each of the plurality of windings;
a second inverter including a second DC link to which a second battery is connected, and a plurality of legs connected to the other end of each of the plurality of windings;
a charging terminal to which a charging voltage of an external charger is applied while the external charger is connected to the charging terminal; and
a plurality of nodes including
a first node formed between a positive electrode of the charging terminal and the other end of any one of the plurality of windings,
a second node formed between a negative electrode of the charging terminal and a negative electrode of the first DC link,
a third node formed between the negative electrode of the charging terminal and a negative electrode of the second DC link, and
a fourth node formed between the second node, the third node, and the negative electrode of the charging terminal.

2. The electrified vehicle of claim 1, further comprising a controller configured to determine a charging path for the first battery and the second battery by controlling the first inverter and the second inverter based on voltages of the first battery and the second battery and a maximum charging voltage applicable to the charging terminal.

3. The electrified vehicle of claim 2, wherein the voltage of the first battery is equal to or higher than the voltage of the second battery, and the controller is configured to control the first inverter and the second inverter based on the voltage of the second battery and the maximum charging voltage.

4. The electrified vehicle of claim 3, wherein the controller is configured to control the first inverter and the second inverter such that a charging path, through which the second battery is directly charged with a charging voltage and the first battery is charged using a voltage of the second battery, is formed when the maximum charging voltage is equal to or higher than the voltage of the second battery.

5. The electrified vehicle of claim 4, wherein the controller is configured to control the first inverter and the second inverter such that current caused by the charging voltage is transmitted to the second battery via the first node and the second inverter.

6. The electrified vehicle of claim 5, wherein the controller is configured to control a switching state of the second inverter such that a leg connected to the first node among the plurality of legs of the second inverter is connected to a positive electrode of the second DC link.

7. The electrified vehicle of claim 4, wherein the controller is configured to control the first inverter and the second inverter such that the voltage of the second battery is converted to match the voltage of the first battery through the plurality of windings.

8. The electrified vehicle of claim 7, wherein the controller is configured to control a switching state of the second inverter such that the plurality of legs of the second inverter is connected to the positive electrode of the second DC link, and to control a switching state of the first inverter such that the voltage of the second battery is converted to match the voltage of the first battery through the plurality of windings.

9. The electrified vehicle of claim 7, wherein the controller is configured to control the first inverter and the second inverter such that phase currents applied to the plurality of windings have the same magnitude.

10. The electrified vehicle of claim 3, wherein the controller is configured to control the first inverter and the second inverter such that a charging path, through which the first battery is charged with the charging voltage and the second battery is charged using the voltage of the first battery, is formed when the maximum charging voltage is lower than the voltage of the second battery.

11. The electrified vehicle of claim 10, wherein the controller is configured to control the first inverter and the second inverter such that current caused by the charging voltage is transmitted to the first battery via the first node, a winding connected to the first node among the plurality of windings, and the first inverter.

12. The electrified vehicle of claim 11, wherein the controller is configured to control a switching state of a leg connected to the first node among the plurality of legs of the first inverter such that the charging voltage is converted to match the voltage of the first battery through the winding connected to the first node among the plurality of windings.

13. The electrified vehicle of claim 10, wherein the controller is configured to control the first inverter and the second inverter such that a current caused by the voltage of the first battery is transmitted to the second battery via windings disconnected to the first node among the plurality of windings, and the second inverter.

14. The electrified vehicle of claim 13, wherein the controller is configured to control switching states of legs disconnected to the first node among the plurality of legs of the first inverter such that the voltage of the first battery is converted to match the voltage of the second battery through the windings disconnected to the first node among the plurality of windings.

15. The electrified vehicle of claim 10, wherein the controller is configured to control the first inverter and the second inverter such that phase currents applied to the plurality of windings have the same magnitude.

16. The electrified vehicle of claim 1, further comprising:
a first switch electrically connecting the first node and the positive electrode of the charging terminal in a turn-on state;
a second switch electrically connecting the second node and the negative electrode of the charging terminal in a turn-on state; and
a third switch electrically connecting the third node and the negative electrode of the charging terminal in a turn-on state.
